(19) United States
(12) Patent Application Publication
(10) Pub. No.: US 2018/0085958 A1
(43) Pub. Date: Mar. 29, 2018

(54) MULTIPURPOSE UTILITY KNIFE SYSTEM

(71) Applicant: GOTOOL UNLIMITED, INC., Tequesta, FL (US)

(72) Inventor: Miles Heitzeberg, Tequesta, FL (US)

(21) Appl. No.: 15/279,422

(22) Filed: Sep. 28, 2016

(51) Int. Cl. B26B 29/02; B26B 11/00; A45F 5/02

(52) U.S. Cl. CPC B26B 29/025; A45F 5/021; B26B 11/008

(57) ABSTRACT

A multipurpose utility knife system comprising at least one knife, a holster, and at least one knife accessory. The knife and the knife accessory can be fastened to or secured in to the holster. The knife has features to make construction-type tasks easier with features such as an illuminating portion, contoured grips, a textured grip portion, reference marks, a serrated edge, and a smooth edge on the knife blade. A knife accessory such as a squeegee has an attachment member that corresponds to a holster attachment member. The holster can be worn and holds the knife in a holster pouch and a knife accessory in coordination with the holster attachment member for providing semi-permanent storage without hindering availability and without interfering with other materials in a construction-type setting.

### FIELD OF THE DISCLOSURE

The present disclosure relates to a multipurpose utility knife system. More specifically, the present disclosure presents a system useful for heating, ventilation, and air conditioning tasks such as insulating air ducts in residential and commercial buildings. The system comprises a knife, a knife accessory, and a knife holster.

### BACKGROUND OF THE DISCLOSURE

Construction professionals traditionally use blades and knifes for cutting and shaping various construction materials such as tape and insulation. Heating, ventilation, and air conditioning (“HVAC”) professionals in particular need knives or blades to slice through thick, multilayered insulation and rigid, woven duct tape and metallic flat tape for the common tasks of insulating and repairing air ducts to increase cooling, thermal, and overall energy efficiency in both residential and commercial settings. Sometimes, these tasks involve the need to use several tools in small, dark crawl spaces, cellars, or attics.

HVAC professionals traditionally need, in addition to using knives and blades, a light source, a serrated blade, a smooth blade, a squeegee or other hand-held laminating device, duct tape, a ruler or measuring tape for completing tasks such as wrapping insulation around air ducts. The smooth blade would be necessary for slicing smoothly through flat tape whereas the serrated blade would be used for making rougher cuts through thick fiberglass insulation. The HVAC professional would first cut the insulation, wrap the insulation around the duct, and then tape the insulation at the seam. The tape would need to be measured with a ruler or measuring tape and then cut with a smooth blade. A squeegee or other laminating device would be used to smooth the flat tape so that an effective, air-tight seal could be made. A separate light source such as a mini flashlight would traditionally be used for locating the tools that are needed. Combination tools typically are not strong and durable enough for HVAC insulation tasks and will break easily.

Since these HVAC tasks are performed in small, dark spaces, lugging around a toolbox is not efficient or practical. Traditionally, several tools would be held in a bulky tool belt that would often need to be removed, so the HVAC professional could access the tools while also fitting in the crawl space. Tools frequently would be lost or fall out of the toolbox or bulky tool belt. The tool belts would traditionally be constructed of hard shell plastic, metal, or thick leather to prevent the knife from poking or tearing through the belt. It is also not practical to store the tools in one's pocket because HVAC work requires kneeling, squatting, and crawling, so the knives and other tools would be forced out of the pocket or possibly stab the person carrying the tools. In some instances, the traditional tool boxes and tool belts would interfere with or damage other construction materials, insulation, or duct work due to their bulkiness and inability to secure the amount of tools required for HVAC tasks.

### SUMMARY OF THE DISCLOSURE

What is needed is a system for simplifying construction tasks comprising at least one knife, at least one knife accessory, and at least one knife holster. The system eliminates the need for carrying bulky toolboxes or tool belts, eliminates the risk of damage to the person and to other construction materials, eliminates the risk of losing tools in small, dark construction areas such as crawl spaces.

The system provides for a reduction of the number of separate tools needed for installing or repairing HVAC insulation. The system provides for at least six tools: a light source, a serrated blade, a smooth blade, a measuring device, a handheld laminating device, and a tool belt to be reduced to three separate tools. The three separate tools are a knife, a knife accessory, and a holster.

The knife has a handle comprising an illuminating portion, a knife handle cap, a contoured top grip, a contoured bottom grip, and a knife base. The knife has a knife blade comprising at least one reference mark, a serrated edge, and a smooth edge. The knife is capable of cutting insulation and tape. The illuminating portion is capable of emitting light. The knife handle cap is capable of providing an additional tool.

The knife accessory is a handheld laminating device or a squeegee comprising a knife accessory attachment member on a knife accessory side. The knife accessory attachment member is capable of removably attaching to a coordinating holster attachment member.

The holster comprises a holster body with a knife securing member, a holster pouch, a holster shield, a holster attachment member, and a holster loop. The holster attachment member is capable of removably attaching to a knife accessory attachment member. The holster is capable of accommodating a belt through the holster loop. The holster with a belt through the holster loop is capable of fastening around a person's limb, waist, or chest.

The system provides for semi-permanent storage of and greater access to the knife and the knife accessory whereby the holster secures the knife blade in the holster pouch and beneath the holster shield and whereby the knife securing member removably fastens around the knife handle and whereby the holster attachment member removably attaches to the knife accessory attachment member.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a front view of an exemplary multipurpose utility knife system with its separate components: a knife, a holster, and a knife accessory.

FIG. 2 illustrates a front view of an exemplary multipurpose knife system having a knife secured in a holster and a knife accessory removably attached to the holster.

FIG. 3 illustrates a perspective view of an exemplary embodiment of a multipurpose knife system with a knife secured in a holster, a knife accessory removably attached to the holster, and a belt threaded through a holster loop.

### REFERENCE NUMERALS OF THE DRAWINGS

The following list refers to the drawings:

1 Knife

3 Knife distal end

6 Knife proximal end

9 Knife tip

12 Knife handle cap

15 Knife handle

18 Contoured bottom grip

21 Knife base

24 Serrated edge

27 Knife blade

30 Smooth edge

33 Reference mark

36 Contoured top grip

39 Textured grip portion

42 Illuminating portion

45 Holster

48 Holster body front side

51 Holster distal end

54 Knife securing member

57 Holster pouch

60 Holster shield

63 Holster proximal end

66 Holster attachment member

69 Holster pouch opening

72 Knife accessory

75 Knife accessory attachment member

78 Knife accessory side

81 Holster body rear side

84 Holster loop

87 Belt

### DETAILED DESCRIPTION

The present disclosure provides generally for a knife and accessory system for use in construction-type settings. According to the present disclosure, the multipurpose utility knife system comprises at least one knife, a holster, and at least one knife accessory. The knife and the knife accessory may be fastened to or secured in to the holster. The knife may have features to make construction-type tasks easier with features such as an illuminating portion, contoured grips, a textured grip portion, reference marks, a serrated edge, and a smooth edge on the knife blade. A knife accessory such as a squeegee has an attachment member that corresponds to a holster attachment member. The holster can be worn around the waist, around a limb, or in a vest-type holster around the chest and holds the knife in a holster pouch and a knife accessory in coordination with the holster attachment member for providing semi-permanent storage without hindering availability and without interfering with other materials in a construction-type setting such as for installing, deconstructing, and repairing HVAC duct insulation.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

Generally, the exemplary system described herein is a multipurpose utility knife system that is useful in various construction settings. The system is particularly useful for HVAC professionals and for duct insulation tasks, but the applicability of the system is not limited to HVAC professionals or HVAC tasks. The system provides for reducing at least six essential HVAC insulation tools to three.

### Detailed Descriptions of the Drawings

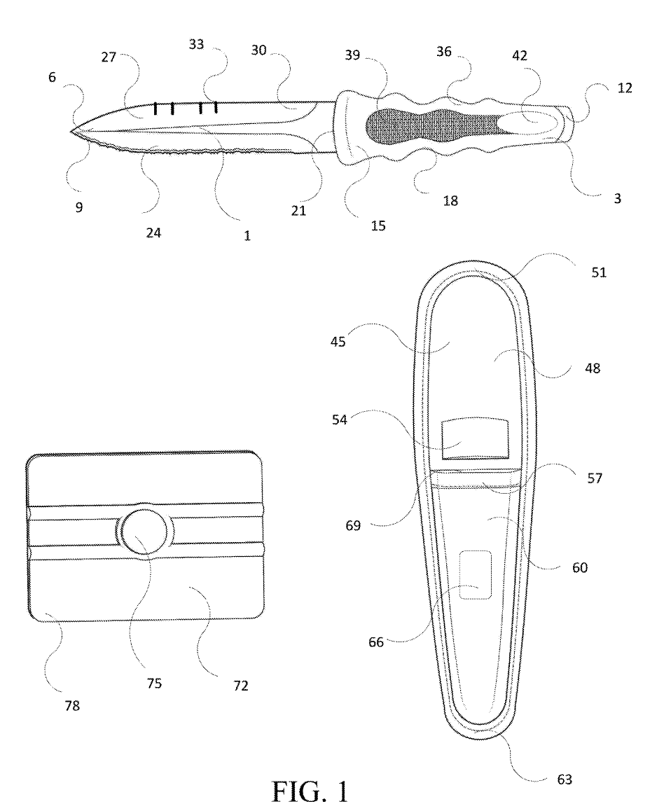

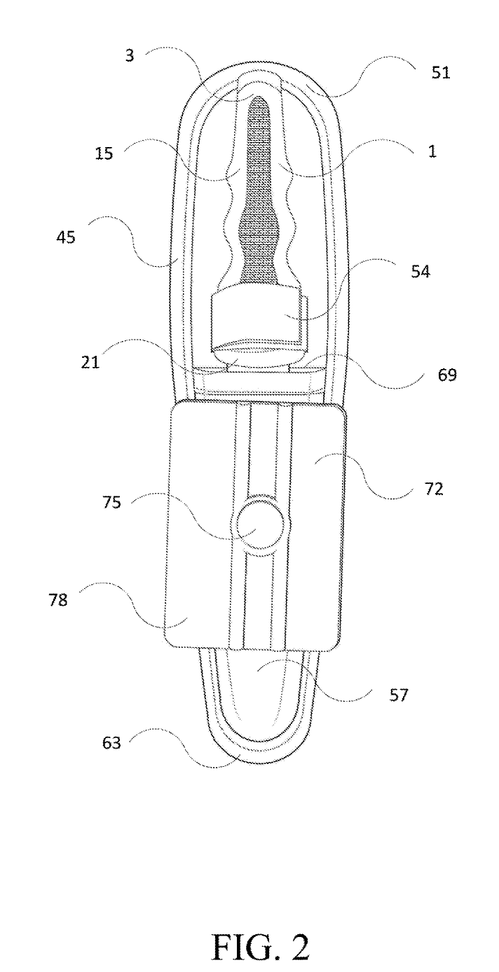

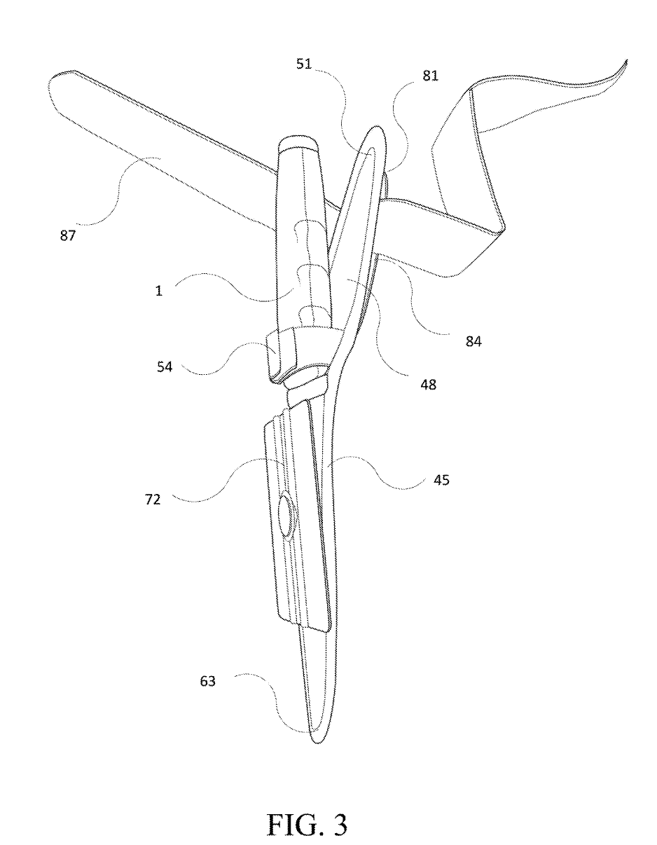

The multipurpose utility knife system is illustrated in FIGS. 1, 2, and 3 to provide exemplary embodiments of the system and the three primary components: a holster 45, a knife, 1, and a knife accessory 72. FIGS. 2 and 3 illustrate alternative views of an exemplary multipurpose utility knife system.

The knife 1 and knife accessory 72 become integrated with the holster 45 to provide for a simple, slim, and secure system for performing construction tasks, especially HVAC tasks that need to be completed in small, dark crawl spaces, attics, and cellars where HVAC ducts are typically located.

The knife 1 is a multipurpose tool solution that replaces a separate light source, a ruler or measuring tape, a smooth blade, and a serrated blade. The knife accessory 72 may be any handheld tool for use in HVAC tasks, but a preferred embodiment is a handheld laminating device such as a squeegee. The knife 1 and the knife accessory 72 are semi permanently secured to the holster 45. This exemplary system eliminates the need to carrying five different tools in a bulky tool belt or tool box. Instead, only two separate tools plus the holster are required. This exemplary system also eliminates the hassle and inconvenience of individual tools falling out of place, getting lost, or interfering with the surrounding, narrow crawl space.

Referring to FIG. 1, a front view of an exemplary multipurpose utility knife system with its separate components, a knife, a holster, and a knife accessory, is illustrated. The knife 1 has a knife distal end 3, a knife proximal end 6, a knife blade 27, and knife handle 15, a knife base 21, and a knife handle cap 12. Additionally, the knife 1 may have a knife tip 9 at the knife proximal end 6, a smooth edge 30, a serrated edge 24, at least one reference mark 33, a contoured top grip 36, a contoured bottom grip 18, a textured grip portion 39, and an illuminating portion 42.

The knife handle cap 12 is located at the knife distal end 3. The knife handle cap 12 may be removably attached to the knife handle 15. The knife handle cap 12 may provide for an additional tool function such as the ability to use the knife handle cap 12 as a hammer. In some embodiments, the knife handle cap 12 may have different shapes such as blunt end, tapered end, or conical end, or may be shaped in the form of tools such as a screw driver or a wrench.

The knife handle 15 may have a longitudinal barrel shape or may have a tapered barrel shape with a tapered portion at the knife distal end 3. The knife handle 15 may be solid or hollow. If the knife handle 15 is hollow, then storage room may be provided for additional knife handle caps 12 or illuminating portion 42 components. The knife handle 15 may be made out of a natural material such as a metal or wood, or may be made out of a synthetic material such as a plastic. The knife handle 15 may have a length of about three inches to about 8 inches, measured from the knife distal end 3 to the knife base 21. The knife handle 15 may have a width of about one quarter of an inch to three inches.

The knife handle may have at least one side with a contoured grip, either a contoured top grip 36, a contoured bottom grip 18, or both a contoured top grip 36 and a contoured bottom grip 18. The contouring may be in a shape or pattern to improve gripping with a hand. Examples include a tapered scalloped pattern or a series of depressions and peaks. The contoured grip 36 or 18 may have three peaks and 4 depressions. A person's fingers are placed in each depression, and the peaks are set in between each finger. A persons hand palm and thumb may come in contact with a textured grip portion 39 on the knife handle 15.

The textured grip portion 39 may comprise of a semi-soft, rubberized layer with a texture for improving grip, friction, and traction. In some embodiments, the textured grip portion 39 may be part of the knife handle material itself 15 with a pattern engraved into the handle, or the textured grip portion 39 may comprise of a texturized or smooth covering such a rubber, plastic, silicone, or sandpaper-type.

The knife handle 15 may have an illuminating portion 42 present on at least one surface of the knife handle 15. The illuminating portion 42 has the capability to emit light. The illuminating portion 42 may be comprised of an extruded plastic with phosphorescent or glow-in-the-dark particles that harvest and store ultraviolet rays and then emit the stored ultraviolet rays in the form of light. In other embodiments, the illuminating portion 42 may have bulbs or light-emitting diodes coupled to a solar panel, or the illuminating portion 42 may have at least one light bulb or diode connected to a battery which is connected to a switch or other light activator.

The knife 1 has a knife blade 27 that may be from about three inches to about nine inches long, measured from the knife base 21 to the knife proximal end 6. The knife blade 27 may be between 2 and 8 millimeters thick. The knife blade 27 may be made out of a metal alloy, solid metal, metal composite, ceramic, coated metal, or carbon-reinforced metal. The knife blade 27 is preferably a shatter-resistant blade. The knife blade 27 is fixably attached to the knife handle 15 at the knife base 21. The knife blade 27 may be attached with friction, with a puzzle-like securing structure inside the knife handle 15, may be attached with an adhesive, or the knife handle 15 may be molded over the knife blade 27.

The knife blade 27 may have a knife tip 9 at the knife proximal end 6. The knife tip 9 may be blunt or may be sharp. In preferred embodiments, the knife tip 9 is sharp to facilitate easy puncture into thick insulation and HVAC duct work.

The knife blade 27 may have a double beveled or slimmed top and bottom edge. One edge may be a smooth edge 30. The smooth edge 30 is useful for making smooth, clean cuts through woven, thick, or flat HVAC and duct tape. The knife blade 27 may also have a serrated edge 24 on the opposite edge. The serrated edge is useful for making rigid cuts into thick insulation and thick fiberglass duct work. The serrated portion may have angular teeth or scalloped teeth with varying depths and patterns, depending on the desired abrasiveness and friction.

The knife blade 27 may have at least one reference mark 33. A reference mark 33 may be an indicator of measurement. There may be a series of reference marks on the knife blade 27 and continuing on to the knife handle 15. The serrated edge 24, the smooth edge 30, or both edges may have reference marks 33. The reference marks 33 may indicate length in inches or centimeters or millimeters, or all three. The reference marks 33 may also have the capability to emit light in the same manner as the illuminating portion 42.

The system comprises a knife accessory 72. The knife accessory 72 is preferably a handheld laminating device such as a squeegee but may be any other tool or accessory typically used in HVAC or construction tasks in connection with a knife. The knife accessory 72 may be made out of an extruded plastic or a molded plastic, or the knife accessory 72 may be made out of a natural material such as wood or metal. The knife accessory 72 may have light emitting capability like the illuminating portion 42. The knife accessory 72 may have a polygonal shape such as an octagon or square or may be circular. The knife accessory 72 may have beveled edges and raised portions for gripping.

The knife accessory 72 has at least one side 78 that may be flat or may also have raised portions. The knife accessory 72 has at least one knife attachment member 75 on the surface of the knife accessory side 78. The knife attachment member 75 may be ferromagnetic, an extruded magnetic polymer, hook fabric or loop fabric, snap, button, adhesive, or tack that coordinates with its opposite on the holster attachment member 66 on the holster 45.

The knife accessory 72 is preferably a hand held laminating device such as a squeegee that is used along with the knife 1 for HVAC applications such as the installation, deconstruction, and repair of HVAC insulation and duct work. A person may use the knife tip 9 to puncture fiberglass insulation and then cut the insulation with the serrated edge 24. Then a person may use the smooth edge 30 to cut flat tape, store the knife 1 in the holster 45, and then apply the flat tape to the duct work. The person may then obtain the knife accessory 72 squeegee to facilitate tape application and physically laminate the tape to the insulation or duct work. Then the knife accessory 72 may be coupled with the knife accessory attachment member 75 to the holster attachment member 66.

The system comprises a holster 45. The holster 45 has a holster body front side 48, a holster body rear side 81 (see FIG. 3), a holster distal end 51, a knife securing member 54, a holster pouch 57, a holster shield 60, a holster proximal end 63, a holster attachment member 66, a holster pouch opening 69, and a holster loop 84 (See FIG. 3).

The holster 45 has a length and width sufficient for storing the corresponding knife 1. The holster 45 may be made out of a natural material such as leather or metal, a synthetic material such as silicone or plastic, or a fabric material such as woven polyester or acetate. In some embodiments, a holster 45 with a woven material made include carbon fiber reinforcements for strength and durability. The holster 45 may have components with the same light emitting capability as the illuminating portion 42.

The knife securing member 54 and the holster pouch 57 are fixably attached to the holster body front side 48. In embodiments where the holster 45 is made out of woven fabric, then the knife securing member 52, holster loop 84, and the holster pouch 57 may be sewn to the holster body front side 48 or holster body rear side 81. The knife securing member 54 may be a piece of material that is sufficiently flat and flexible and that is fixably attached near the center of the holster body front side 48 and at least two millimeters above the holster pouch opening 69, closer to the holster distal end 51. The knife securing member 54 may have corresponding loop fabric on one end and hook fabric on the other end, cooperating and coordinating snaps, magnets, or other closure types that removably connect when securing a knife handle 15 in place.

The holster pouch 57 may have a tapered shape to accommodate a corresponding knife 1. The holster pouch 57 has a holster pouch opening 69 for receiving a knife blade 27. A holster shield 60 and a holster attachment member 66 may be integrated with a holster pouch 57, either on the surface of the holster pouch 57 or inside the holster pouch. A holster shield 60 may be an extruded plastic insert or covering in or on top of the holster pouch 57. The holster shield 60 provides rigidity and structure for securing the knife blade 27 and preventing the knife tip 9, the smooth edge 30, or the serrated edge 24, from prodding or poking through the holster 45.

The holster attachment member 66 may be fixedly attached to the outside surface of the holster pouch 57 or may be fixedly attached to the inside of the holster pouch 57, between the holster shield 60 and the holster pouch 57, so as to not come into direct contact with a stored knife blade 27. The holster attachment member 66 has a corresponding attachment means that coordinates with the knife accessory attachment member 75. The holster attachment member 66 may have corresponding loop fabric on one end and hook fabric on the other end, cooperating and coordinating snaps, magnets, or other closure types that removably connect when securing a knife handle 15 in place. The holster attachment member 66 and the knife accessory attachment member 75 may be ferromagnetic with coordinating north and south poles.

In some embodiments, a belt 87 may be threaded through the holster loop 84. The holster loop 84 may be a piece of material that is sufficiently flat and flexible and that is fixably attached to the holster body rear 81 and preferably at or near the holster distal end 51. The holster loop 84 may provide enough room to accommodate a belt 87 that may have a width up to six inches. The holster loop 84 has enough room to accommodate a belt 87 having a width of at least three inches. The belt 87 may then be fastened around a person's limb, waist, or chest. The holster 45 may have one or more holster loops 84. The belt 87 may fasten to a person with a hook-and-eye closure, traditional belt buckle, loop and friction, magnetic closure, snaps, or by tying.

When wearing the system, a person can easily bend, crawl, or squat in a small and dark environment such as crawl space in an HVAC or construction setting and still be able to access the knife 1 and the knife accessory 72. Likewise, a person can easily store the knife 1 by sliding the knife blade 27 through the holster pouch opening 69 and into the holster pouch 57 and optionally fastening the knife securing member 54 around the knife handle 15. A person can also easily avoid losing the knife accessory 72 by coupling the knife accessory attachment member 75 to the holster attachment member 66.

### Conclusion

Several embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. Nevertheless, it will be understood that various modifications may be made without departing from the spirit and scope of the claimed disclosure.

What is claimed is:

1. A multipurpose knife system for construction applications, the system comprising a knife, a knife accessory, and a holster.

2. The system of claim 1 wherein the knife comprises a proximal end, a distal end, a knife blade, a knife base, and a knife handle, wherein the knife blade is fixably attached to the knife handle at the knife base.

3. The knife blade of claim 2 further comprising a serrated edge, a knife tip, a smooth edge, and at least one reference mark.

4. The knife handle of claim 2 further comprising a knife handle cap, and an illuminating portion.

5. The knife handle of claim 4 further comprising a textured grip portion.

6. The knife handle of claim 4 whereby the illuminating portion is capable of emitting light.

7. The knife handle of claim 2 further comprising a contoured top grip and a contoured bottom grip.

8. The knife handle of claim 4 further comprising a contoured top grip.

9. The knife handle of claim 4 further comprising a contoured bottom grip.

10. The knife handle of claim 4 further comprising a contoured top grip and a contoured bottom grip.

11. The knife handle of claim 2 further comprising at least one reference mark.

12. The knife handle of claim 4 whereby the knife handle cap is capable of providing removable interchangeable tool attachment.

13. The system of claim 1 wherein the knife accessory is a handheld laminating device or a squeegee comprising a knife accessory attachment member on a knife accessory side.

14. The knife accessory of claim 13 whereby the knife accessory attachment member is capable of removably attaching to a coordinating holster attachment member.

15. The system of claim 1 wherein the holster comprises a holster distal end, a holster proximal end, a holster body front side, a holster body rear side, a holster attachment means, a holster shield, a holster pouch, a holster pouch opening, a knife securing member, and a holster loop.

16. The holster of claim 15 whereby the holster attachment member is capable of accommodating a belt through the holster loop, whereby the belt is capable of fastening around a person's limb, waist, or chest.

17. A multipurpose knife system for construction applications, the system comprising a knife, a knife accessory, and a holster,
wherein the knife comprises
a knife blade having a serrated edge, a smooth edge, a knife tip, and at least one reference mark;
a knife handle fixably attached to the knife blade at a knife base, the knife handle having at least one contoured grip, a knife handle cape, and an illuminating portion;
wherein the knife accessory is a squeegee and comprises
at least one knife accessory side and at least one knife accessory attachment member;
whereby the knife accessory attachment member is capable of removably attaching to a coordinating holster attachment member;
wherein the holster comprises
a holster body with a front side and a rear side, a knife securing member, a holster pouch,
a holster pouch opening, a holster shield, a holster attachment member, and a holster loop;
whereby the holster pouch is capable of receiving a knife blade and whereby the knife securing member is capable of removably fastening around the knife handle, and
whereby the holster attachment member is capable of removably attaching to the knife accessory attachment member.

18. The system of claim 17 wherein the illuminating portion is capable of emitting light from harvested and stored ultraviolet rays.

19. The system of claim 17 wherein the knife accessory attachment member and the holster attachment member are ferromagnetic with coordinating north and south poles.

20. A method for providing an HVAC tool system that reduces the number of separate tools required for installing, deconstructing, or repairing HVAC insulation, the method steps comprising
obtaining a holster having a holster pouch, a holster pouch opening, a holster shield, a holster attachment member, a knife securing member, and a holster loop;
sliding a belt through the holster loop and fastening the belt around a person's limb, waist, or chest;
obtaining a knife comprising a knife blade fixably attached to a knife handle at a knife base, wherein the knife blade has a serrated edge, a smooth edge, at least one reference mark and wherein the knife handle has at least one contoured grip, a knife handle cap, an illuminating portion, and at least one reference mark;
placing the knife blade through the holster pouch opening and into the holster pouch wherein the holster shield lies on top of the knife blade within the holster pouch;
fastening the knife securing member around the knife handle;
obtaining a knife accessory, the knife accessory being a handheld laminating device comprising at least one knife accessory side and a knife accessory attachment member; and
coupling the knife accessory with the holster whereby the knife accessory attachment member cooperatively contacts the region of the holster where the holster attachment member is located.
